(19) United States
(12) Patent Application Publication
(10) Pub. No.: US 2026/0027683 A1
(43) Pub. Date: Jan. 29, 2026

(54) SYSTEMS AND METHODS FOR DISPLACING A BUSHING ASSEMBLY RELATIVE TO A STRUCTURAL MEMBER

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/278,525

(22) Filed: Jul. 23, 2025

Related U.S. Application Data
(60) Provisional application No. 63/675,687, filed on Jul. 25, 2024.

(51) Int. Cl. B25B 27/06

(52) U.S. Cl. CPC B25B 27/06

(57) ABSTRACT

A bushing assembly displacement system comprises a pull system comprising a guide plate defining a guide edge discontinuity, a push system comprising a guide tube defining a guide surface discontinuity, and a drive system comprising a drive rod. The pull system is configured to be operatively connected to the bushing assembly such that the guide edge discontinuity engages the structural member. The push system is configured to be operatively connected to the bushing assembly such that guide surface discontinuity engages the bushing assembly. The rod is operatively connected to the pull system. Operation of the drive system displaces the drive rod to displace the bushing assembly and the guide plate while the guide tube engages the bushing assembly such that the guide plate and the guide tube maintain the bushing assembly in a desired orientation as the bushing assembly moves within the opening defined by the structural member.

### RELATED APPLICATIONS

This application (Attorney's Ref. No. P220681) claims benefit of U.S. Provisional Application Ser. No. 63/675,687 filed Jul. 25, 2024, the contents of which are incorporated herein by reference.

### TECHNICAL FIELD

The present invention relates to systems and methods for displacing bushing assemblies and, more specifically, to systems and methods for displacing bushing assemblies relative to a structural member defining an opening configured to receive the bushing assembly.

### BACKGROUND

Vehicles often use bushing assemblies to connect two vehicle parts to each other such that transmission of vibrations between the two vehicle parts is inhibited. Bushing assemblies typically comprise a coupler member, a bushing housing, and a bushing sleeve. The bushing assembly is typically arranged within a spring opening defined by a spring end of a vehicle suspension system. The coupler member is then operatively connected to the vehicle frame.

Vehicle maintenance and repair often requires that the bushing assembly be removed and replaced. The present invention is of particular significance during the installation of a replacement bushing assembly, and that application of the present invention will be described herein.

To install a bushing assembly, the bushing assembly is aligned with the spring opening and then a driving force is applied to the bushing assembly to force the bushing assembly into the spring opening.

In some bushing assemblies, the bushing housing is made of non-cylindrical plastic and can easily be damaged during installation of the bushing assembly into the spring opening.

The need exists for bushing assembly displacement systems and methods that facilitate the insertion of replacement bushings in a proper orientation relative to the spring opening while not damaging the non-cylindrical housing of the bushing assembly.

### SUMMARY

The present invention may be embodied as a bushing assembly displacement system for displacing a bushing relative to a structural member defining an opening. The bushing assembly displacement system comprises a pull system, a push system, and a drive system. The pull system comprises a guide plate defining a guide edge discontinuity. The push system comprises a guide tube defining a guide surface discontinuity. The drive system comprises a drive rod. The pull system is configured to be operatively connected to the bushing assembly such that the guide edge discontinuity engages the structural member. The push system is configured to be operatively connected to the bushing assembly such that guide surface discontinuity engages the bushing assembly. The rod is operatively connected to the pull system. Operation of the drive system displaces the drive rod to displace the bushing assembly and the guide plate while the guide tube engages the bushing assembly such that the guide plate and the guide tube maintain the bushing assembly in a desired orientation as the bushing assembly moves within the opening defined by the structural member.

The present invention may also be embodied as a method for displacing a bushing assembly relative to a structural member defining an opening, the method comprising the following steps. A pull system comprising a guide plate defining a guide edge discontinuity is provided. A push system comprising a guide tube defining a guide surface discontinuity is provided. A drive system comprising a drive rod is provided. The pull system is configured to be operatively connected to the bushing assembly such that the guide edge discontinuity engages the structural member. The push system is configured to be operatively connected to the bushing assembly such that guide surface discontinuity engages the bushing assembly. The drive rod is configured to be operatively connected to the pull system. The drive system is operated such that the drive system displaces the drive rod and the drive rod displaces the pull system and the bushing assembly such that the guide plate and bushing assembly are displaced relative to the structural member while the guide tube and the guide plate maintain the bushing assembly in a desired orientation as the bushing assembly moves within the opening defined by the structural member.

The present invention may also be embodied as a bushing assembly displacement system for displacing a bushing assembly defining a bushing projection relative to a structural member defining an opening. The bushing assembly displacement system comprises a pull system, a push system, and a drive system comprising a drive rod. The pull system comprises a pull coupling member and a guide plate defining a guide edge discontinuity. The push system comprises a push coupling member and a guide tube defining a guide surface discontinuity. The pull system is configured to be operatively connected to the bushing assembly such that the guide edge discontinuity engages the structural member. The push system is configured to be operatively connected to the bushing assembly such that the push coupling member engages at least a portion of the bushing assembly and the guide surface discontinuity is arranged to engage the bushing projection. The pull coupling member is operatively connected to the drive rod. Operation of the drive system displaces the drive rod to displace the pull system and the bushing assembly such that the guide plate and bushing assembly are displaced relative to the structural member while the guide tube and the guide plate maintain the bushing assembly in a desired orientation as the bushing assembly moves within the opening defined by the structural member.

### BRIEF DESCRIPTION OF THE DRAWINGS

FIG. 1 is top plan view of a first example bushing assembly displacement system configured to displace a bushing assembly into a spring opening of a structural member;

FIG. 2 is a top plan exploded view of the first example bushing displacement system, an example bushing assembly, and an example structural member;

FIG. 3 is a side elevation view of an example bushing assembly that may be displaced using the first example bushing displacement system;

FIG. 4 is a rear elevation view, taken along lines 4-4 in FIG. 2, of an example structural member defining a spring opening configured to receive the example bushing assembly of FIG. 3;

FIG. 5 is a rear elevation view, taken along lines 5-5 in FIG. 2, of a guide plate of the first example bushing assembly displacement system;

FIG. 6 is a rear elevation view, taken along lines 6-6 in FIG. 2, of the example bushing assembly;

FIG. 7 is a rear elevation view, taken along lines 7-7 in FIG. 2, of guide tube of the first example bushing displacement system;

FIG. 8 is a longitudinal section view depicting the first example bushing displacement assembly, the example bushing assembly, and the example structural member, where the first example bushing displacement assembly is in an initial stage of a process of installing the example bushing assembly;

FIG. 9 is a section view taken along lines 9-9 in FIG. 8;

FIG. 10 is a longitudinal section view depicting part of the first example bushing displacement assembly, the example bushing assembly, and the example structural member, where the first example bushing displacement assembly is in an intermediate stage of the process of installing the example bushing assembly; and

FIG. 11 is a longitudinal section view depicting part of the first example bushing displacement assembly, the example bushing assembly, and the example structural member, where the first example bushing displacement assembly is in a final stage of the process of installing the example bushing assembly.

### DETAILED DESCRIPTION

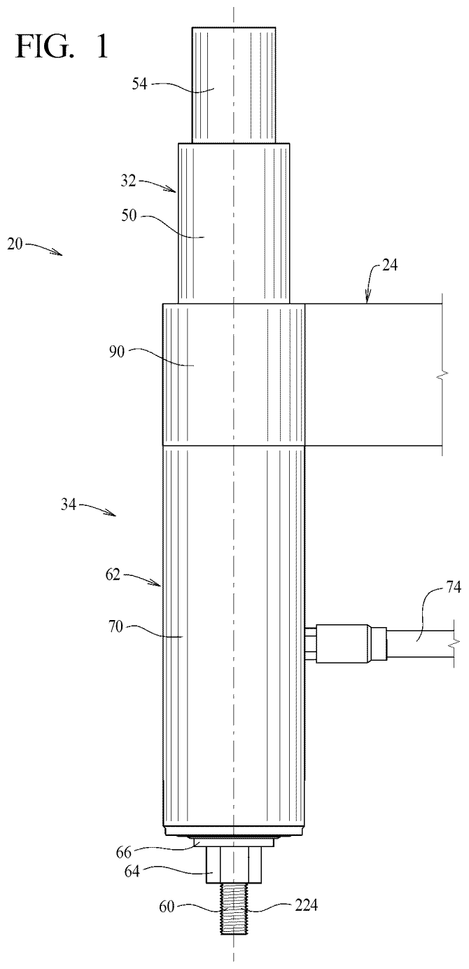

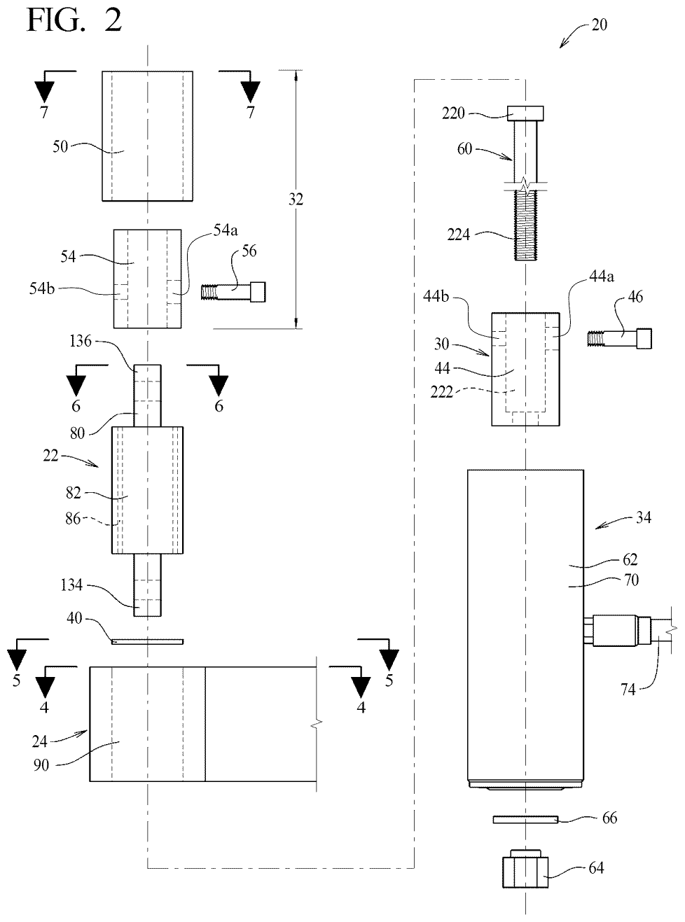

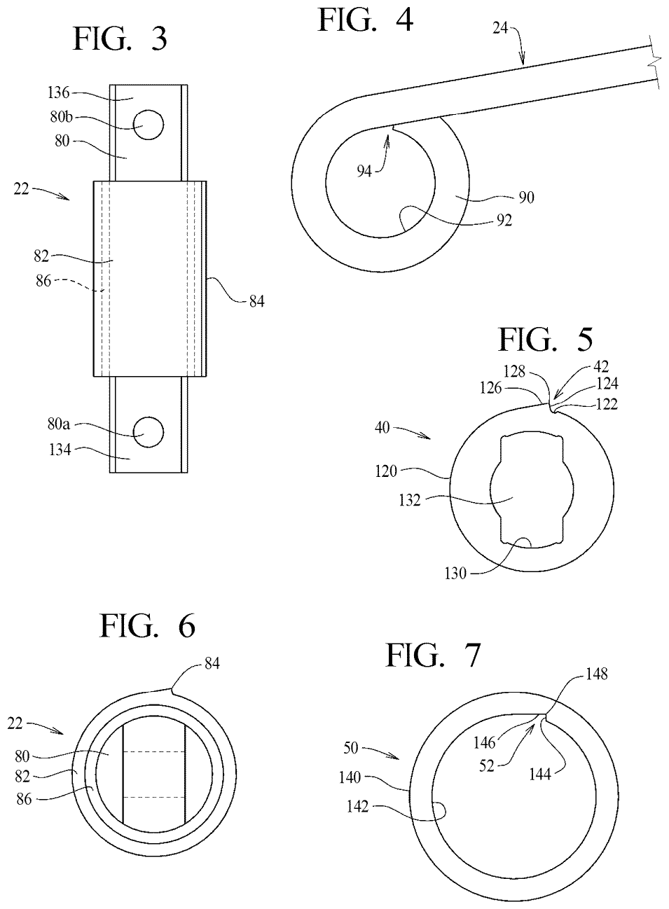

FIGS. 1, 2, and 8 depict a first example bushing assembly displacement system 20 configured to displace a bushing assembly 22 relative to a structural member 24. The first example bushing assembly displacement system 20 comprises a pull system 30, a push system 32, and a drive system 34. The example pull system 30 comprises a guide plate 40 defining a guide edge discontinuity 42, a pull coupler 44, and a pull coupler bolt or member 46. The example push system 32 comprises a guide tube 50 defining a guide surface discontinuity 52, a push coupler 54, and a push coupler bolt or member 56. The example drive system 34 comprises a drive rod 60, a drive actuator 62, a drive nut 64, and a drive washer 66. The example drive actuator 62 comprises an actuator housing assembly 70 and a drive piston 72 and is operatively connected to a fluid supply 74. The example bushing assembly 22 comprises a bushing coupler 80, a bushing housing 82 defining a bushing housing projection 84, and a bushing sleeve 86. The example structural member 24 is a spring member defining a spring end 90. The spring end 90 is configured to define a spring opening 92. The example spring opening 92 defines a spring opening notch 94.

The example pull system 30 is configured to operatively connect the drive rod 60 to a first coupler opening 80a of the bushing coupler 80 through the pull coupler 44 and the pull coupler bolt 46. The push coupler 54 of the example push system 32 is operatively connected between a second coupler opening 80b of the bushing coupler 80 by the push coupler bolt 56. The guide plate 40 is arranged between the pull coupler 44 and the bushing housing 82, and the guide tube 50 is arranged around the push coupler 54. The guide edge discontinuity 42 on guide plate 40 engages the structural member 24 and the bushing assembly 22 to support the bushing assembly 22 in a desired alignment with the spring opening 92. The guide surface discontinuity 52 on the guide tube 50 further engages the bushing housing 82 to maintain the desired alignment of the bushing assembly 22 with the spring opening 92 as the bushing assembly 22 is forced into the spring opening 92.

Given the foregoing basic understanding of the construction and operation of the present invention, the details of the first example bushing assembly displacement system 20 will now be described in further detail.

The example bushing assembly displacement system 20 is configured specifically to accommodate the example bushing assembly 22 and example structural member 24. The example bushing assembly 22 and the example structural member 24 are or may be conventional, are not per se part of the present invention, and thus will not be described herein beyond that extent helpful to an effective understanding of the construction and operation of the first example bushing displacement assembly 20.

The example bushing housing projection 84 is arranged to engage the spring opening notch 94 to maintain proper alignment of the bushing assembly 22 and the structural member 24. When properly aligned with the structural member 24, the bushing coupler 80 is in proper alignment for connection to other components of a suspension system (not shown) incorporating the structural member 24 and the bushing assembly 22 supported thereby. And for a variety of reasons, the bushing housing 82 may be made of a relatively soft material such as plastic. Given that minimal tolerances are formed between the bushing assembly 22 and the spring end 90 defining the spring opening 92, even a slight misalignment of the bushing assembly 22 relative to the spring opening 92 can damage the bushing assembly 22.

The example pull system 30 is operatively connected to the example bushing assembly 22 via the pull coupler bolt 46. The example pull coupler bolt 46, or pull coupling member, is or may be a conventional threaded bolt, pin, or other a similar retaining member that is configured to extend through the pull coupler 44 and the bushing coupler 80 to operatively connect the pull system 30 to the bushing assembly 22. The example pull coupler bolt 46 further connects the pull coupler 44 to the drive rod 60. In alternative embodiments, the drive rod 60, the pull coupler 44, and pull coupler bolt 46 may be formed as a singular integral structure. The example pull coupler bolt 46 defines a pull coupler bolt first portion 46a, a pull coupler bolt second portion 46b, and a pull coupler bolt third portion 46c. The pull coupler bolt first portion 46a is arranged in a first pull coupler opening 44a defined by the pull coupler 44 configured to receive the head of the pull coupler bolt 46. The pull coupler bolt second portion 46b is arranged in the bushing coupler opening 80a. The pull coupler bolt third portion 46c is or may be threaded and is configured to engage a second pull coupler opening 44b defined by the pull coupler 44.

The example push system 32 is operatively connected to the bushing assembly 22 via the push coupler bolt 56. The example push coupler bolt 56, or push coupling member, is or may be a conventional threaded bolt, detent pin, or other a similar retaining member that is configured to extend through the push coupler 54 and the bushing coupler 80 to operatively connect the push system 32 to the bushing assembly 22. The example push coupler bolt 56 defines a push coupler bolt first portion 56a, a push coupler bolt second portion 56b, and a push coupler bolt third portion 56c. The push coupler bolt first portion 46a is arranged in a first coupler opening 54a defined by the push coupler 54. The push coupler second portion 56b is arranged in the bushing coupler opening 80b. The push coupler bolt third portion 56c is configured to engage a second coupler opening 54b defined by the push coupler 54.

The example guide plate 40 and guide tube 50 are configured and dimensioned to maintain a desired alignment of the bushing assembly 22 relative to the structural member 24 as the example bushing assembly displacement 20 displaces the bushing assembly 22 into the spring opening 92.

In particular, the guide plate 40 defines a perimeter edge 120 on which the guide edge discontinuity 42 is formed. Except for the guide edge discontinuity 42, the perimeter edge 120 is circular in shape as shown in FIG. 5. The example guide edge discontinuity 42 comprises a first discontinuous edge portion 122 that curves inwardly from the circular portion of the perimeter edge 120, a second discontinuous edge portion 124 that extends outwardly from the first discontinuous edge portion 122, a third discontinuous edge portion 126 that extends from the second discontinuous edge portion 124 to the circular portion of the perimeter edge 120, and a discontinuous edge portion tip 128 at the juncture of the second and third discontinuous edge portions 124 and 126. The particular shape formed by the guide edge discontinuity 42 is not, in general, critical, but should be configured substantially to match the spring opening notch 94 of the spring opening 92 and the bushing housing projection 84 defined by bushing housing 82.

In particular, the example guide edge discontinuity 42 is configured substantially to match the shapes of the spring opening notch 94 and the bushing housing projection 84. The example guide plate perimeter edge 120, and in particular, the guide edge discontinuity 42 formed as a part of the guide plate perimeter edge 120 are thus configured and arranged to engage both the spring end 90 and the bushing housing 82 to arrange the bushing assembly 22 in proper alignment with the spring opening 92 and in particular the spring opening notch 94.

In addition, the example guide plate 40 comprises an inner edge 130 that defines a guide plate opening 132. The example inner edge 130 is configured such that the guide plate opening 132 is sized and dimensioned to receive a first end portion 134 of the example bushing coupler 80 so that the guide plate 40 may engage the bushing housing 82 and/or the bushing sleeve 86 with the guide edge discontinuity 42 substantially aligned with the bushing housing projection 84. The particular shape formed by the inner edge 130 and guide plate opening 132 is not, in general, critical, but should be configured substantially to match a shape of the first end portion 134 of the coupler member to index or otherwise properly align the guide edge discontinuity 42 with the bushing housing projection 84 when the guide plate 40 is supported by the end of the bushing coupler 80.

The example guide tube 50 is generally cylindrical and comprises an external surface 140 and an internal surface 142 as perhaps best shown in FIG. 7. The example external surface 140 is cylindrical, and the example internal surface 142 is substantially cylindrical and coaxially aligned with the external surface 140. The example guide surface discontinuity 52 is formed on the example internal surface 142 such that a thickness of the example guide tube 50 is substantially consistent except at the guide surface discontinuity 52. In particular, the guide surface discontinuity 52 defines a first guide surface discontinuity portion 144 that extends from the cylindrical portion of the internal surface 142, a second guide surface discontinuity portion 146 that extends from the first guide surface discontinuity portion 144 back to the cylindrical portion of the internal surface 142, and a guide surface intersection line 148 formed at the juncture of the first and second guide surfaced discontinuity portion 144 and 146. The particular shape formed by the guide surface discontinuity 52 is not, in general, critical, but should be configured substantially to match the bushing housing projection 84 defined by bushing housing 82.

As with the example guide edge discontinuity 42 formed on the guide plate 40, the example guide surface discontinuity 52 is configured substantially to match the shapes of the spring opening notch 94 and the bushing housing projection 84. The example guide tube inner surface 142, and, in particular, the guide surface discontinuity 52 defined thereby, thus allow the example guide tube 50 to receive at least a portion of the example bushing assembly 22 immediately prior to and during the process of installing the bushing assembly 22 into the structural member 24 using the first example bushing assembly displacement system 20.

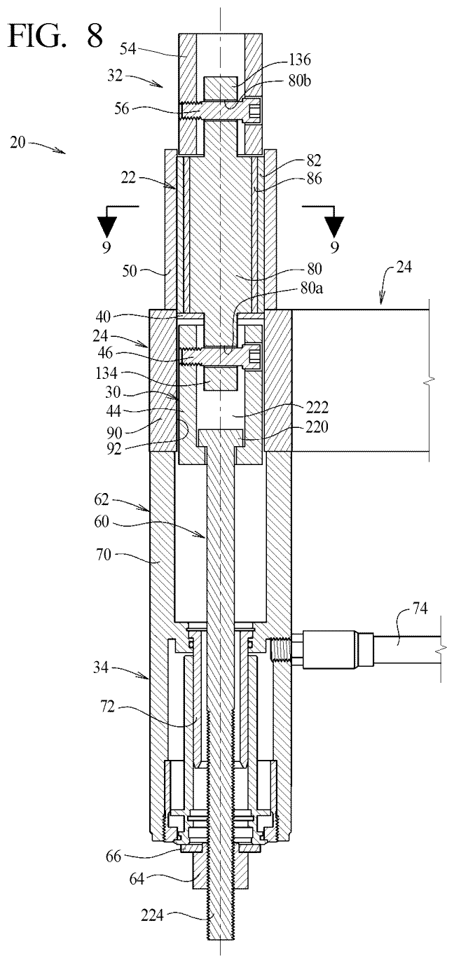

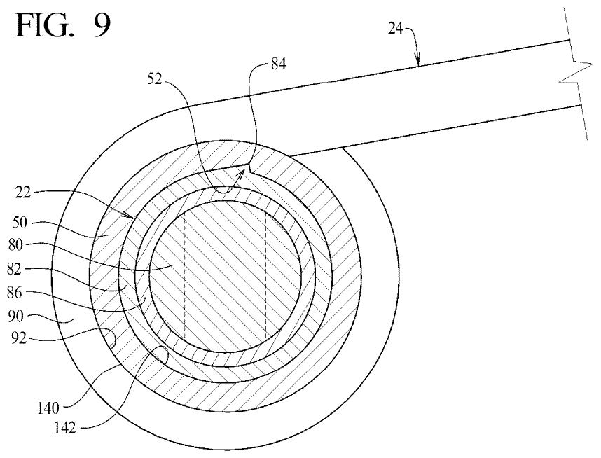

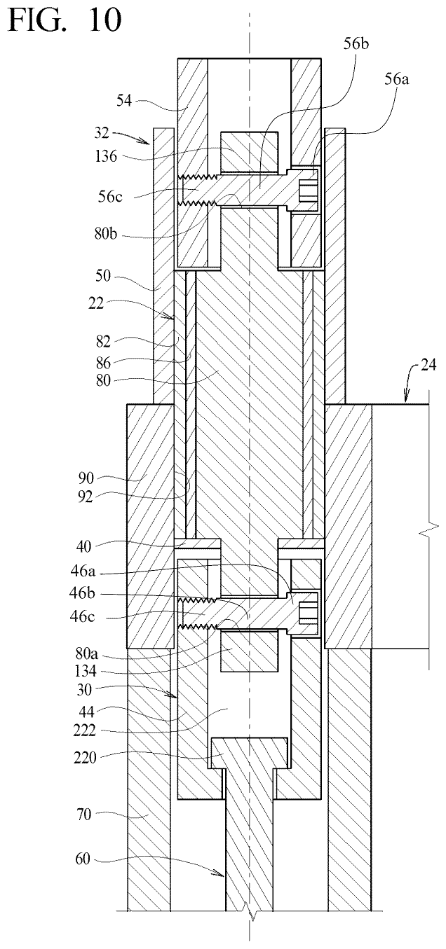

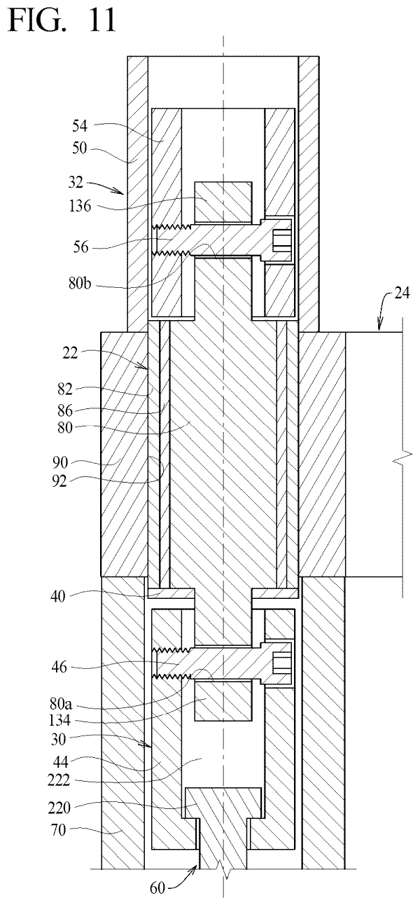

Referring now to FIGS. 8-11, the use of the first example bushing assembly displacement system 20 will now be described.

Referring initially to FIG. 8 of the drawing, the guide plate 40 is arranged such that the guide plate opening 132 receives a portion of the bushing coupler 80 and the guide edge discontinuity 42 is substantially aligned with the bushing housing projection 84. More specifically, the example bushing coupler 80 comprises a first coupler end 134 and a second coupler end 136. The example first coupler end 134 is inserted through the guide plate opening 132 and the guide edge discontinuity 42 substantially aligned with the bushing housing projection 84.

The drive rod 60 is next arranged with a guide rod head 220 within a pull coupler cavity 222 defined by the pull coupler 44. The pull coupler bolt 46 is then arranged to join the pull coupler 44 and the first coupler end 134 of the bushing coupler 80. The bushing assembly 22, the guide plate 40, the pull coupler 44, the pull coupler bolt 46, and the drive rod 60 are then displaced together such that the pull coupler 44 and pull coupler bolt 46 are within the spring opening 92 and the drive rod extends out of the spring opening 92. At this point, the bushing assembly 22, the guide plate 40, the pull coupler 44, the pull coupler bolt 46, and the drive rod 60 are all rotated slightly and pressed against the spring end 90 such that the guide plate discontinuity 42 engages with the spring end 90 and is received by the spring opening notch 94 to index the bushing assembly 22 in the desired relationship relative to the spring end 90.

Next, the push coupler 54 is connected to the second coupler end 136 using the push coupler bolt 56. The guide tube 50 is then arranged such that the guide surface discontinuity 52 is aligned with the bushing housing projection 84 and then displaced such that at least a portion of the bushing housing 82 is within the guide tube 50 as shown in FIG. 8.

At this point, the actuator housing assembly 70 is displaced relative to the drive rod 60 such that at least a portion of a threaded end portion 224 of the drive rod 60 extends out of the actuator housing assembly 70. The drive washer 66 is then arranged over the exposed portion of the threaded end portion 224 of the drive rod 60. The drive nut 64 is then threaded onto the exposed portion of the threaded end portion 224 of the drive rod 60 such that a distance between the pull coupler 44 and the drive washer 66 is fixed. At this point, the first example bushing assembly displacement system 20 is configured and arranged to begin the process of driving the bushing assembly 22 into the spring opening 92 defined by the structural member 24.

Allowing pressurized fluid to flow from the fluid supply 74 into the actuator housing assembly (i.e., operation of the drive system 34) displaces the drive piston 72, which in turn displaces the drive washer 66, drive nut 64, drive rod 60, and pull coupler 44 relative to the structural member 24. Because the pull coupler 44 is connected to the bushing coupler 80, displacement of the pull coupler 44 causes displacement of the bushing coupler 80. And because the bushing coupler 80 is in turn connected to the push coupler 54, displacement of the bushing coupler 80 causes displacement of the push coupler 54. Displacement of the push coupler 54 in turn displaces the bushing housing 82 and bushing sleeve 86. And finally, displacement of the bushing housing 82 and bushing sleeve 86 in turn displaces the guide plate 40. Accordingly, operation of the drive system 34 causes the guide plate 40 and bushing assembly 22 to be displaced into the spring opening 92 as shown in FIG. 9.

The guide tube 50 is held by the structural member 24 and remains in place as the bushing assembly 22 enters the spring opening 92. However, the guide tube 50 helps to maintain alignment of the bushing assembly 22 as the bushing assembly 22 is displaced into the spring opening 92.

Continued operation of the drive system 34 further displaces the bushing assembly 22, still in its desired orientation, to a desired position within the spring opening 92. When the bushing assembly 22 is in the desired position within the spring opening 92, operation of the drive system 34 is ceased. The guide tube 50 is removed (or falls off) at this point. The push coupler bolt 56 is then removed to allow the push coupler 54 to be removed from the second coupler end 136. The drive system 34 is next disassembled from the drive rod 60. The pull coupler bolt 46 is then removed to allow the pull coupler 44 to be detached from the first coupler end 134. The bushing assembly 22 is now installed in the spring opening 92 defined by the structural member 24.

As briefly discussed above, bushing assemblies and structural members may be made in a number of different sizes and configurations. Multiple guide plates and guide tubes will be provided defining a guide edge discontinuity and the guide surface discontinuity configured to accommodate each unique size and configuration of the bushing assemblies and structural members. The guide plate 40 and guide tube 50 are shown as examples only, and different configurations of guide plates and guide tubes and different configurations of guide edge discontinuities and guide surface discontinuities may be provided to accommodate a particular configuration of bushing assembly and structural member.

What is claimed is:

1. A bushing assembly displacement system for displacing a bushing assembly relative to a structural member defining an opening, the bushing assembly displacement system comprising:
a pull system comprising a guide plate defining a guide edge discontinuity;
a push system comprising a guide tube defining a guide surface discontinuity; and
a drive system comprising a drive rod; wherein
the pull system is configured to be operatively connected to the bushing assembly such that the guide edge discontinuity engages the structural member;
the push system is configured to be operatively connected to the bushing assembly such that guide surface discontinuity engages the bushing assembly;
the rod is operatively connected to the pull system; and
operation of the drive system displaces the drive rod to displace the pull system and the bushing assembly such that the guide plate and bushing assembly are displaced relative to the structural member while the guide tube and the guide plate maintain the bushing assembly in a desired orientation as the bushing assembly moves within the opening defined by the structural member.

2. The bushing assembly displacement system of claim 1, in which the pull system comprises a pull coupling member wherein the pull coupling member is configured to be operatively connected to the drive rod and the bushing assembly.

3. The bushing assembly displacement system of claim 1 in which the push system comprises a push coupling member wherein the push coupling member is configured to be operatively connected to the bushing assembly.

4. The bushing assembly displacement system of claim 1, in which the guide plate defines a guide plate opening dimensioned to receive at least a portion of the bushing assembly.

5. The bushing assembly displacement system of claim 1, in which the guide tube defines a guide tube opening dimensioned to receive at least a portion of the bushing assembly.

6. The bushing assembly displacement system of claim 1, in which the guide edge discontinuity defines at least one discontinuous edge portion and a discontinuous tip portion.

7. The bushing assembly displacement system of claim 1, in which the guide surface discontinuity is sized and dimensioned to engage a bushing housing projection defined by the bushing assembly.

8. The bushing assembly of claim 1, in which the guide edge discontinuity is sized and dimensioned to engage an opening notch defined by the structural member.

9. A method for displacing a bushing assembly relative to a structural member defining an opening, the method comprising the steps of:
providing a pull system comprising a guide plate defining a guide edge discontinuity;
providing a push system comprising a guide tube defining a guide surface discontinuity;
providing a drive system comprising a drive rod;
configuring the pull system to be operatively connected to the bushing assembly such that the guide edge discontinuity engages the structural member;
configuring the push system be operatively connected to the bushing assembly such that guide surface discontinuity engages the bushing assembly;
configuring the drive rod to be operatively connected to the pull system; and
operating the drive system such that the drive system displaces the drive rod and the drive rod displaces the pull system and the bushing assembly such that the guide plate and bushing assembly are displaced relative to the structural member while the guide tube and the guide plate maintain the bushing assembly in a desired orientation as the bushing assembly moves within the opening defined by the structural member.

10. The method of claim 9, in which the step of providing a pull system comprises
providing a pull coupling member; and
configuring the pull coupling member to be operatively connected to the drive rod and the bushing assembly.

11. The method of claim 9, in which the step of providing a push system comprises
providing a push coupling member; and
configuring the push coupling member to be operatively connected to the bushing assembly.

12. The method of claim 9, in which the step of providing a pull system comprises configuring the guide plate to define a guide plate opening dimensioned to receive at least a portion of the bushing assembly.

13. The method of claim 9, in which the step of providing a push system comprises configuring the guide tube to define a guide tube opening dimensioned to receive at least a portion of the bushing assembly.

14. The method of claim 9, in which the step of providing a pull system comprises configuring the guide edge discontinuity to define at least one discontinuous edge portion and a discontinuous tip portion.

15. The method of claim 9, in which the step of providing the push system comprises configuring the guide surface discontinuity to be sized and dimensioned to engage a bushing housing projection defined by the bushing assembly.

16. The method of claim 9, in which step of providing the pull system comprises configuring the guide edge discontinuity to be sized and dimensioned to engage an opening notch defined by the structural member.

17. A bushing assembly displacement system for displacing a bushing assembly defining a bushing projection relative to a structural member defining an opening, the bushing assembly displacement system comprising:
a pull system comprising a pull coupling member, and
a guide plate defining a guide edge discontinuity;
a push system comprising
a push coupling member, and
a guide tube defining a guide surface discontinuity; and
a drive system comprising a drive rod; wherein
the pull system is configured to be operatively connected to the bushing assembly such that the guide edge discontinuity engages the structural member;
the push system is configured to be operatively connected to the bushing assembly such that the push coupling member engages at least a portion of the bushing assembly and the guide surface discontinuity is arranged to engage the bushing projection;
the pull coupling member is operatively connected to the drive rod; and
operation of the drive system displaces the drive rod to displace the pull system and the bushing assembly such that the guide plate and bushing assembly are displaced relative to the structural member while the guide tube and the guide plate maintain the bushing assembly in a desired orientation as the bushing assembly moves within the opening defined by the structural member.

18. The bushing assembly displacement system of claim 1, in which the guide plate defines a guide plate opening dimensioned to receive at least a portion of the bushing assembly.

19. The bushing assembly displacement system of claim 1, in which the guide tube defines a guide tube opening dimensioned to receive at least a portion of the bushing assembly.

20. The bushing assembly displacement system of claim 1, in which the guide surface discontinuity is sized and dimensioned to engage a bushing housing projection defined by the bushing assembly.

21. The bushing assembly of claim 1, in which the guide edge discontinuity is sized and dimensioned to engage an opening notch defined by the structural member.
